(19) United States
(12) Patent Application Publication
(10) Pub. No.: US 2006/0286265 A1
(43) Pub. Date: Dec. 21, 2006

(54) Food composition comprising a satiety enhancing amount of triacylglycerol and use in the manufature of a medicament for the treatment or prevention of obesity

(76) Inventors: Bengt Herslof, Stockholm (SE); Annika Viberg, Jarfalla (SE)

Correspondence Address: DICKSTEIN SHAPIRO LLP, 1177 AVENUE OF THE AMERICAS (6TH AVENUE), NEW YORK, NY, 10036-2714, US

(21) Appl. No.: 10/540,505

(22) PCT Filed: Dec. 21, 2003
(86) PCT No.: PCT/SE03/02054

§ 371 Date: Jun. 8, 2006

(30) Foreign Application Priority Data
Dec. 27, 2002 (SE) 0203886-7

(51) Int. Cl. A23D 7/00

(52) U.S. Cl. 426/602

(57) ABSTRACT

In a method of controlling satiety a food product comprising a satiety controlling amount of a food additive, which consists of a triacylglycerol or a mixture of triacylglycerols, and an emulsifier is provided to a person. Acyl is tetradecanoyl to eicosanoyl, optionally mono- or di-unsaturated, optionally alpha-monosubstituted with saturated C₁-C₄ alkyl. More than 15 mole-% of total acyl is comprised by alpha-substituted acyl. The person is directed to consume the food product from 1 h to 8 h prior to a meal. Thereby the amount of food consumed in the meal is reduced in comparison with the amount of food consumed in a corresponding meal following, by a corresponding time difference, the consumption of a food product of equal energy content but lacking the additive. Also disclosed are corresponding additives and compositions comprising them, and their use.

### FIELD OF THE INVENTION

The present invention relates to a glycerol ester product which is useful as a food additive for satiety control, a method for satiety control comprising administration of the glycerol ester product to a person in need thereof, and a food composition comprising the glycerol ester product.

### BACKGROUND OF THE INVENTION

Excess energy intake by over-consumption of food is considered a major health problem, in particular in the Western world. Various methods and food products that counter such intake are known in the art. One particular kind of energy intake reducing products is based on the concept that food products with a high fat content bring about a feeling of satiety soon after ingestion. On the other hand, such food products are rich in calories and thus should only be ingested in comparatively small amounts. Thus a delicate balance between satiety effect onset and energy intake necessary to achieve that effect has to be stricken.

WO 99/02041 discloses a food composition giving a prolonged feeling of satiety comprising a mixture of triglyceride oils, in particular a oil-in-water emulsion thereof, having a solid fat content at ambient to body temperature and a food emulsifier, such as lecithin, galactolipids and fractionated oat oil. While the food composition of WO 99/02041 has been shown to provide the desired effect in practice, the energy intake by the body due to its consumption is of a size which far from optimal. Thus there is room for improvement in regard of satiety control products based on fat.

### OBJECTS OF THE INVENTION

It is an object of the present invention to provide a satiety control product of the aforementioned kind, which is improved in regard of the energy intake necessary to obtain a desired satiety feeling.

It is another object of the invention to provide a method of satiety control by use of said satiety control product.

Further objects of the invention will become evident from the study of the following summary of the invention, the description of a preferred embodiment thereof, and the appended claims.

### SUMMARY OF THE INVENTION

The invention is based on the hypothesis that the hydrolysis of triacylglycerols in the gastrointestinal tract by the action of lipases will be retarded if one or several of the acyl rests are substituted in α-position by an alkyl rest, and that this will delay the onset of hunger, thus leading to a reduced energy intake during a subsequent meal which is consumed within the span of time in which the appetite is suppressed, such as up to eight hours and more.

According to the present invention is disclosed a satiety control product comprising an satiety enhancing amount of a triacylglycerol or a mixture of triacylglycerols the acyl residues of which are selected from the group consisting of tetradecanoyl to eicosanoyl, optionally mono- or di-unsaturated, optionally α-monosubstituted with saturated C₁-C₄ alkyl, with the proviso that more than 15 mole-% of total acyl residues are comprised by α-substituted acyl residues, and a food emulsifier.

Preferred triacylglycerols according to the invention are those which comprise hexadecanoyl and/or octadecanoyl residues and corresponding acyl residues alkylated, in particular, methylated in α-position. The distribution of the acyl residues between the glycerol entities may be statistic or given. In other words, for instance, 1-(2-methylhexadecanoyl)-2,3-dioctadecanoyl glycerol (“ordered”) and the “statistic” mixture of (2-methylhecadecanoyl), (octadecanoyl) glycerols comprising these acyl rests in a 1:2 molar ratio, obtained by, for instance, from of the a corresponding ordered compound by acid or alkali catalysed trans-esterification, are both comprised by the invention.

Preferred α-alkyl substituents are C₁-C₄ saturated alkyl, in particular methyl, ethyl, propyl, isoproyl, butyl, isobutyl but, exceptionally, alkyl groups comprising up to 9 carbon atoms may be used. Most preferred is methyl, ethyl, propyl as α-substituent.

Thus, in particular, according to the invention is disclosed a food composition comprising a satiety enhancing amount of a triacylglycerol or a mixture of triacylglycerols, the acyl residues of which are selected from the group consisting of tetradecanoyl to eicosanoyl, optionally mono- or di-unsaturated, optionally α-monosubstituted with saturated C₁-C₄ alkyl, with the proviso that more than 15 mole-% of total acyl residues are comprised by α-substituted acyl residues, and a food emulsifier. Preferably more than 50 mole-%, more preferred more than 80 mole-%, even more preferred more than 90 mole-%, most preferred more than 95 mole-%, of said α-substituted acyl residues are comprised by a member of the group consisting of 2-methyltetradecanoyl, 2-methylhexadecanoyl, 2-methyloctadecanoyl, 2-methyleicosanoyl, and mixtures thereof.

According to a preferred aspect of the invention the emulsifier comprises lecithin, and/or galactolipid. It is preferred for the galactolipid to be comprised by fractionated oat oil.

According to first preferred aspect the food composition of the invention is an oil-in-water emulsion.

The food composition of the invention is particularly suitable for the treatment or prevention of obesity.

According to a second preferred aspect of the invention is disclosed a food additive essentially consisting of a triacylglycerol or a mixture of triacylglycerols, the acyl residues of which are selected from the group consisting of tetradecanoyl to eicosanoyl, optionally mono- or di-unsaturated, optionally α-monosubstituted with saturated C₁-C₄ alkyl, with the proviso that more than 15 mole-% of total acyl residues are comprised by α-substituted acyl residues, a food emulsifier and, optionally, one or several of water, sodium chloride, antioxidant, colorant, flavouring. The food emulsifier is preferably selected from lecithin, galactolipid, and their mixtures.

According to a third preferred aspect of the invention is disclosed a food product comprising an obesity-preventing amount of the aforementioned food additive. The food product may be in form of a dairy product, in particular in form of yoghurt, cream, sour cream, milk, butter or a butter substitute comprising milk fat, ice cream. The food product of the invention may however also be in form of a non-dairy product.

According to a fourth preferred aspect of the invention is disclosed a method of controlling satiety in a person, comprising:
providing to said person a food product comprising a satiety controlling amount of a food additive essentially consisting of a triacylglycerol or a mixture of triacylglycerols, the acyl residues of which are selected from the group consisting of tetradecanoyl to eicosanoyl, optionally mono- or di-unsaturated, optionally α-monosubstituted with saturated C₁-C₄ alkyl, with the proviso that more than 15 mole-% of total acyl residues are comprised by α-substituted acyl residues, a food emulsifier and, optionally, one or several of water, sodium chloride, antioxidant, colorant, flavouring; and
directing said person to consume said food product from 1 h to 8 h prior to a meal selected from lunch, dinner, supper,
   thereby reducing the amount of food consumed in the meal in comparison with the amount of food consumed in a corresponding meal following, by a corresponding time difference, the consumption of a food product of equal energy content but lacking said food additive. It is preferred that more than 50 mole-%, in particular more than 80 mol-%, more particularly more than 90 mol-%, most preferred more than 95 mole-%, of the triacylglycerol mixture are 1-(2-methylocta-decanoyl)-2,3-dihexadecanoyl-glycerol. Also preferred is for about a third of the acyl residues of the triacylglycerol mixture to be octadecanoyl and for about two thirds to be 1-(2-methyloctadecanoyl).

### DESCRIPTION OF A PREFERRED EMBODIMENT

Materials. A mixture of (hexadecanoyl)ₓ-(1-methyloctadecanoyl)_{y}-glycerols in which x+y=3 was obtained by trans-esterification of corresponding molar amounts of tripalmitin and tri-(2-methylstearoyl)glycerol in n-hexane with sodium methoxide as catalyst. The reaction was carried out in an inert atmosphere. The reaction product was washed with water and hexane; it may be purified by chromatography on silica gel with 2-propanol and hexane. It is a white powder essentially consisting of an isomer mixture of tripalmitin, tri(2-methylstearoyl)glycerol, 1,2-di(2-methyl-stearoyl)-3-palmitoylglycerol, 1,3-di(2-methyl-stearoyl)-2-palmitoylglycerol, 1-(2-methylstearoyl)-2,3-dipalmitoylglycerol, and 1,3-dipalmitoyl-2-(2-methylstearoyl)glycerol.

Tri(2-methylstearoyl)glycerol was prepared by acylating glycerol in the presence of pyridine with 2-methyloctadecanoyl chloride prepared from 2-methyloctadecanoic acid and thionyl chloride.

1-(2-methyloctadecanoyl)-2,3-dihexadecanoyl-glycerol was prepared from 1-(2-methyloctadecanoyl)-2,3-isopropylidene glycerol (Gronowitz, S. et al., Lipids 32:6 (1997) 6667-673) by reaction with 2 moles of 2-methyloctadecanoyl chloride in the presence of pyridine according to Procedure B, ibid., p. 667. Other triacylglycerols suitable in the invention, such as tris(2-methyloctadecanoyl)glycerol, are disclosed in Gronowitz et al. or can be prepared by adapting the methods of Gronowitz et al. in a manner which is within the easy reach of the person skilled in the art.

### EXAMPLE 1

### Preparation of Triglyceride Test Emulsions

The following oil-in-water test emulsions containing 20% by weight of triglyceride were prepared by mixing the components listed in Table 1 with distilled water using a high-speed stirrer.

TABLE 1
Composition of test emulsions, in % by weight, rest water

| | Fractionated | Fractionated | Triacylglycerols |
|---|---|---|---|
| Test Emulsion | Palm Oil | Oat Oil | of the Invention |
| Prior Art (A) | 40 | 2.5 | 0 |
| Invention (B) | 0 | 2.5 | 10 |

### EXAMPLE 2

### Preparation of Test Yoghurt

Yoghurt products for testing were prepared ex tempore by mixing equal amounts of the test emulsions with a commercial low fat yoghurt (Lätt-Yoggi; Arla, Stockholm, Sweden). The fat content of the test yoghurts was normalized to 3% by weight obtained by adding double cream to the low fat products to compensate for differences in energy content. The composition of the test yoghurts is shown in Table 2.

TABLE 2
Composition of test yoghurts

| | | Amount of | | |
|---|---|---|---|---|
| | | Test | Amount of | |
| Test | Amount of | Emulsion | Double Cream | Total Fat |
| emulsion | Yoghurt (g) | Added (g) | Added (g) | Content (g) |
| Prior Art (A) | 187.5 | 12.5 | 0 | 6 |
| Invention (B) | 187.5 | 2.5 | 11.75 | 6 |
| Control | 187.5 | 0 | 12.5 | 6 |

### EXAMPLE 3

### Mean Intake at Lunch Following Yoghurt Breakfast

Twelve non-overweight healthy volunteers (six men and six women) were given 200 g yoghurt for breakfast at 8 o'clock in the morning. At noon the volunteers were served a test meal (lunch) at which they had free access to a wide range of familiar foods. For each person, all test meal foods were weighed prior to the meal, and all uneaten foods was weighed after the meal. Intake was assessed by difference in weight of food. The tests were performed on three days separated by an interval of one week. The study was of a single-blind randomised crossover design. The test persons were asked to fast from 8 o'clock in the evening of the preceding day and to refrain from heavy exercise on that day and on the day when the test was performed. They were instructed to not consumed anything except non-carbonated water between the test breakfast and the test lunch. The results of the test are given in Table 3.

TABLE 3
Mean energy intake at test lunch

| | Energy | Energy | Energy | Energy | Energy |
|---|---|---|---|---|---|
| | Intake, | Intake, | Consump- | Intake, | Consump- |
| Volun- | Yoghurt | Yoghurt + | tion, Yo- | Yoghurt + | tion, Yo- |
| teers | (Control) | B | ghurt + B | C | ghurt + C |
| Male | 7.01 | 5.57 | −20.5 | 5.24 | −25.2 |
| Female | 5.12 | 3.89 | −24.1 | 3.63 | −29.2 |
| Total | 6.07 | 4.71 | −22.3 | 4.41 | −27.2 |

The energy intake at the subsequent meal (test lunch) was reduced for all subjects that had consumed the satiety control product containing the prior art and the inventive test emulsion, respectively. The efficacy of the test emulsion of the invention (C) was however found to be more than ten times higher than that of the prior art emulsion (B).

1-40. (canceled)

41. Food additive comprising a triacylglycerol or mixture of triacylglycerols, the acyl residues of which are selected from the group consisting of tetradecanoyl to eicosanoyl, optionally mono- or di-unsaturated, wherein more than 15 mole-% of total acyl residues are α-substituted acyl residues, a food emulsifier and, optionally, one or more of water, sodium chloride, antioxidant, colorant, and flavoring.

42. The food additive of claim 41, wherein said food emulsifier is selected from lecithin and galactolipid.

43. The food additive of claim 41, wherein at least one acyl residue is monosubstituted with C1-C4 alkyl.

44. The food additive of claim 41 in which 15 mole % or more of the acyl residues are 2-methyloctadecanooyl residues, and at least one other acyl residue is hexdecanoyl.

45. The food additive of claim 43, wherein said acyl residues consist essentially of hexadecanoyl and 2-methyloctadecanoyl.

46. The food additive of claim 45, wherein the molar ratio of hexadecanoyl to 2-methyloctadecanoyl is about 1:2.

47. The food additive of claim 41, wherein the emulsifier is at least one of galactolipid and lecithin.

48. The food additive of claim 47, wherein the emulsifier comprises fractionated oat oil.

49. The food additive of claim 41, in form of an oil-in-water emulsion.

50. Food composition comprising a satiety enhancing amount of a food additive of claim 41.

51. The food composition of claim 50, wherein more than 50 mole-% of said α-substituted acyl residues are a member selected from the group consisting of 2-methyltetradecanoyl, 2-methylhexadecanoyl, 2-methyloctadecanoyl, 2-methyleicosanoyl, and mixtures thereof.

52. The food composition of claim 50, wherein more than 80 mole-% of said α-substituted acyl residues are a member selected from the group consisting of 2-methyltetradecanoyl, 2-methylhexadecanoyl, 2-methyloctadecanoyl, 2-methyleicosanoyl, and mixtures thereof.

53. The food composition of claim 50, wherein more than 90 mole-% of said α-substituted acyl residues a member selected from the group consisting of 2-methyltetradecanoyl, 2-methylhexadecanoyl, 2-methyloctadecanoyl, 2-methyleicosanoyl, and mixtures thereof.

54. The food composition of claim 50, wherein more than 95 mole-% of said α-substituted acyl residues a member selected from the group consisting of 2-methyltetradecanoyl, 2-methylhexadecanoyl, 2-methyloctadecanoyl, 2-methyleicosanoyl, and mixtures thereof.

55. The food composition of claim 50, wherein the food emulsifier comprises at least one of lecithin and galactolipid.

56. The food composition of claim 55, wherein the galactolipid is comprised by fractionated oat oil.

57. The food composition of claim 50 in form of a dairy product.

58. The food composition of claim 50, in form of a non-dairy product.

59. The food composition of claim 50, wherein said α-substituted acyl residue is 2-methyloctadecanoyl.

60. The food composition of claim 50, wherein said acyl residues that are not α-substituted are selected from hexadecanoyl and octadecanoyl.

61. A method of controlling satiety in a person, comprising administration to the person of a satiety enhancing amount of the food additive of claim 50.

62. The method of claim 61, wherein more than 50 mole-% of said triacylglycerol mixture is 1-(2-methyloctadecanoyl)-2,3-dihexadecanoyl-glycerol.

63. The method of claim 61, wherein about a third of said acyl residues are octadecanoyl and about two thirds are 1-(2-methyloctadecanoyl).

64. A triglyceride composition comprising of tripalmitin, tri(2-methylstearoyl)glycerol, 1,2-di(2-methyl-stearoyl)-3-palmitoylglycerol, 1,3-di(2-methyl-stearoyl)-2-palmitoylglycerol, 1-(2-methylstearoyl)-2,3-dipalmitoyl-glycerol, and 1,3-dipalmitoyl-2-(2-methylstearoyl)glycerol.

65. The composition of claim 64, additionally comprising a food emulsifier selected from lecithin and galactolipid.

66. An oil-in-water emulsion consisting essentially of the triglyceride composition of claim 64 and water.
